(19) United States
(12) Patent Application Publication
(10) Pub. No.: US 2025/0139967 A1
(43) Pub. Date: May 1, 2025

(54) EAR FEATURE DETECTION AND LOCATION FOR FACIAL AUGMENTED REALITY

(71) Applicant: Niantic, Inc, San Francisco, CA (US)

(72) Inventors: Dat Tan Chu, San Jose, CA (US); Yuyan Song, Sunnyvale, CA (US); Joel Udwin, Mountain View, CA (US); Nicholas John Butko, Cupertino, CA (US); Sara Alexandra Gomes Vicente, London (GB); Mohamed Amr Abdelfattah Sayed, London (GB); Michael David Firman, London (GB)

(21) Appl. No.: 18/934,083

(22) Filed: Oct. 31, 2024

Related U.S. Application Data
(60) Provisional application No. 63/594,832, filed on Oct. 31, 2023.

(51) Int. Cl. G06V 20/20; A63F 13/213; A63F 13/65; G06T 7/73; G06T 19/20; G06V 10/77; G06V 20/64; G06V 40/16

(52) U.S. Cl. CPC G06V 20/20; A63F 13/213; A63F 13/65; G06T 7/74; G06T 19/20; G06V 10/7715; G06V 20/64; G06V 40/165; G06V 40/171; G06T 2207/30201; G06T 2219/2021

(57) ABSTRACT

A client device provides AR content to a user tracks features of the user's ears. The client device builds a model of the user's head that represents the distances between the user's facial features and features of the user's ears. The client device generates this user head model by identifying facial feature points in an image. The client device also applies an ear feature detection model to the image, which identifies 2D points in the image where ear features are depicted. The client device generates the model based on the 3D facial feature points and the 2D ear feature points. For example, the client device may use a feature relationship model that describes the general relationships between facial features and ear points. Once the client device has generated the user head model, the client device uses the user head model to estimate the position of the ear features in 3D.

### CROSS-REFERENCE TO RELATED APPLICATIONS

This application claims the benefit of U.S. Provisional Application No. 63/594,832, filed Oct. 31, 2023, which is incorporated by reference.

### BACKGROUND

Augmented reality (AR) systems augment images of the physical world to make virtual content appear to exist in the physical world. For example, an AR system may allow a user to try on clothing or jewelry by augmenting images of the user to include the clothing and jewelry that the user wants to try. To generate this virtual content, AR systems may identify the locations of facial features on the user's face. For example, AR systems may apply facial feature detection models that identify where certain facial features are located on a user's face. However, AR systems commonly focus on facial features and fail to identify other features on a user's head that may be relevant to presenting AR content.

### SUMMARY

A client device that provides AR content to a user tracks features of the user's ears. Specifically, the client device builds a model of the user's head that represents the distances between the user's facial features (such as their eyes or mouths) and features of the user's ears (such their ear lobes or ear canals). The client device generates this user head model by identifying facial feature points in an image captured by a camera of the client device. These facial feature points are 3D points that indicate where, in the physical world, a corresponding facial feature is located. The client device also applies an ear feature detection model to the image, which identifies 2D points in the image where ear features are depicted.

The client device generates the user head model based on the 3D facial feature points and the 2D ear feature points. For example, the client device may use a feature relationship model that describes the general relationships between facial features and ear points. For example, the feature relationship model may include statistical distributions for measurements of vectors from facial features to ear points. The client device predicts the 3D locations of ear features by using the feature relationship model. For example, the client device may draw a ray line through the 2D ear feature point representing a set of possible 3D points on which the ear feature may lie, and may use the feature relationship model to predict which of the points on that ray line the ear feature is most likely to be located at.

Once the client device has generated the user head model, the client device uses the user head model to estimate the position of the ear features in 3D. For example, the user head model may only indicate the 3D position of the ear feature relative to facial features. Thus, the client device uses the 3D facial feature points to estimate the 3D position of ear features using the user head model. The client device may use these estimated 3D ear feature positions to generate AR content using the images captured by the client device.

By generating the user head model, the client device can estimate the position of a user's ear features without having to apply more sophisticated and computationally expensive algorithms or models to images captured by the client device. Thus, the client device can reduce the latency in providing AR content to a user.

### BRIEF DESCRIPTION OF THE DRAWINGS

FIG. 1 depicts a representation of a virtual world having a geography that parallels the real world, according to one embodiment.

FIG. 2 depicts an exemplary interface of a parallel reality game, according to one embodiment.

FIG. 3 is a block diagram of a networked computing environment suitable for detecting and tracking ear features, according to one embodiment.

FIG. 4 is a flowchart of a process for detecting and tracking ear features, according to one embodiment.

FIG. 5 illustrates an example use of a ray line through a 2D ear feature point to estimate a 3D location of the corresponding ear feature, according to one embodiment.

FIG. 6 illustrates an example computer system suitable for use in the networked computing environment of FIG. 1, according to one embodiment.

### DETAILED DESCRIPTION

The figures and the following description describe certain embodiments by way of illustration only. One skilled in the art will recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

Various embodiments are described in the context of a parallel reality game that includes augmented reality content in a virtual world geography that parallels at least a portion of the real-world geography such that player movement and actions in the real-world affect actions in the virtual world. The subject matter described is applicable in other situations where detecting and tracking ear features is desirable. In addition, the inherent flexibility of computer-based systems allows for a great variety of possible configurations, combinations, and divisions of tasks and functionality between and among the components of the system.

### Example Location-Based Parallel Reality Game

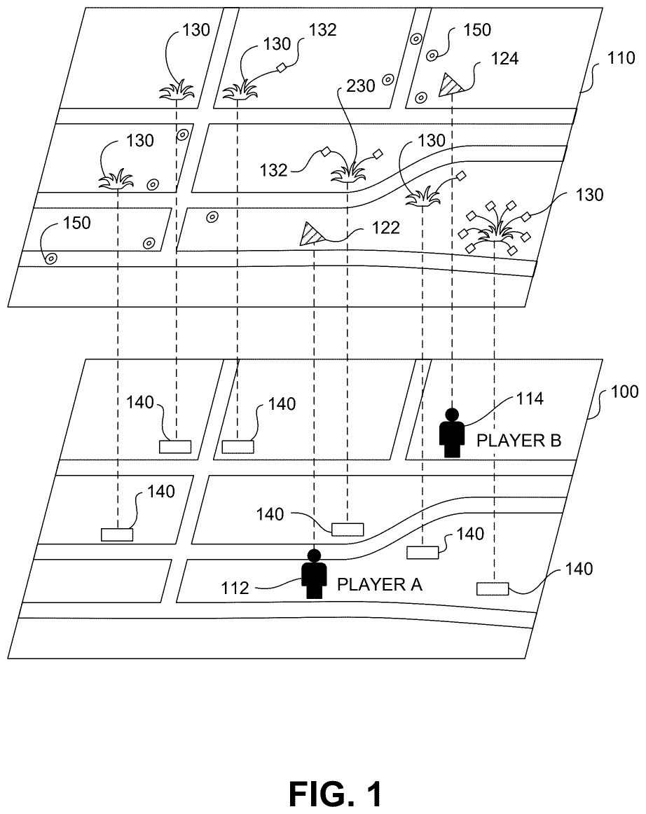

FIG. 1 is a conceptual diagram of a virtual world 110 that parallels the real world 100. The virtual world 110 can act as the game board for players of a parallel reality game. As illustrated, the virtual world 110 includes a geography that parallels the geography of the real world 100. In particular, a range of coordinates defining a geographic area or space in the real world 100 is mapped to a corresponding range of coordinates defining a virtual space in the virtual world 110. The range of coordinates in the real world 100 can be associated with a town, neighborhood, city, campus, locale, a country, continent, the entire globe, or other geographic area. Each geographic coordinate in the range of geographic coordinates is mapped to a corresponding coordinate in a virtual space in the virtual world 110.

A player's position in the virtual world 110 corresponds to the player's position in the real world 100. For instance, player A located at position 112 in the real world 100 has a corresponding position 122 in the virtual world 110. Similarly, player B located at position 114 in the real world 100 has a corresponding position 124 in the virtual world 110. As the players move about in a range of geographic coordinates in the real world 100, the players also move about in the range of coordinates defining the virtual space in the virtual world 110. In particular, a positioning system (e.g., a GPS system, a localization system, or both) associated with a mobile computing device carried by the player can be used to track a player's position as the player navigates the range of geographic coordinates in the real world 100. Data associated with the player's position in the real world 100 is used to update the player's position in the corresponding range of coordinates defining the virtual space in the virtual world 110. In this manner, players can navigate along a continuous track in the range of coordinates defining the virtual space in the virtual world 110 by simply traveling among the corresponding range of geographic coordinates in the real world 100 without having to check in or periodically update location information at specific discrete locations in the real world 100.

The location-based game can include game objectives requiring players to travel to or interact with various virtual elements or virtual objects scattered at various virtual locations in the virtual world 110. A player can travel to these virtual locations by traveling to the corresponding location of the virtual elements or objects in the real world 100. For instance, a positioning system can track the position of the player such that as the player navigates the real world 100, the player also navigates the parallel virtual world 110. The player can then interact with various virtual elements and objects at the specific location to achieve or perform one or more game objectives.

A game objective may have players interacting with virtual elements 130 located at various virtual locations in the virtual world 110. These virtual elements 130 can be linked to landmarks, geographic locations, or objects 140 in the real world 100. The real-world landmarks or objects 140 can be works of art, monuments, buildings, businesses, libraries, museums, or other suitable real-world landmarks or objects. Interactions include capturing, claiming ownership of, using some virtual item, spending some virtual currency, etc. To capture these virtual elements 130, a player travels to the landmark or geographic locations 140 linked to the virtual elements 130 in the real world and performs any necessary interactions (as defined by the game's rules) with the virtual elements 130 in the virtual world 110. For example, player A may have to travel to a landmark 140 in the real world 100 to interact with or capture a virtual element 130 linked with that particular landmark 140. The interaction with the virtual element 130 can require action in the real world, such as taking a photograph or verifying, obtaining, or capturing other information about the landmark or object 140 associated with the virtual element 130.

Game objectives may require that players use one or more virtual items that are collected by the players in the location-based game. For instance, the players may travel the virtual world 110 seeking virtual items 132 (e.g., weapons, creatures, power ups, or other items) that can be useful for completing game objectives. These virtual items 132 can be found or collected by traveling to different locations in the real world 100 or by completing various actions in either the virtual world 110 or the real world 100 (such as interacting with virtual elements 130, battling non-player characters or other players, or completing quests, etc.). In the example shown in FIG. 1, a player uses virtual items 132 to capture one or more virtual elements 130. In particular, a player can deploy virtual items 132 at locations in the virtual world 110 near to or within the virtual elements 130. Deploying one or more virtual items 132 in this manner can result in the capture of the virtual element 130 for the player or for the team/faction of the player.

In one particular implementation, a player may have to gather virtual energy as part of the parallel reality game. Virtual energy 150 can be scattered at different locations in the virtual world 110. A player can collect the virtual energy 150 by traveling to (or within a threshold distance of) the location in the real world 100 that corresponds to the location of the virtual energy in the virtual world 110. The virtual energy 150 can be used to power virtual items or perform various game objectives in the game. A player that loses all virtual energy 150 may be disconnected from the game or prevented from playing for a certain amount of time or until they have collected additional virtual energy 150.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing their locations.

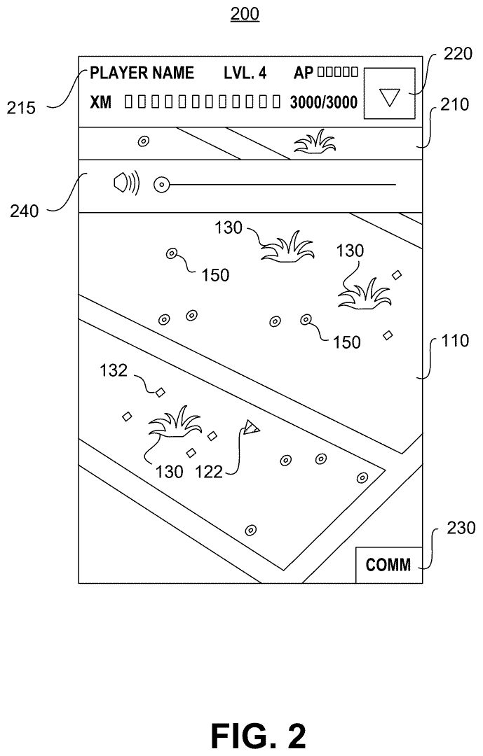

FIG. 2 depicts one embodiment of a game interface 200 that can be presented (e.g., on a player's smartphone) as part of the interface between the player and the virtual world 110. The game interface 200 includes a display window 210 that can be used to display the virtual world 110 and various other aspects of the game, such as player position 122 and the locations of virtual elements 130, virtual items 132, and virtual energy 150 in the virtual world 110. The user interface 200 can also display other information, such as game data information, game communications, player information, client location verification instructions and other information associated with the game. For example, the user interface can display player information 215, such as player name, experience level, and other information. The user interface 200 can include a menu 220 for accessing various game settings and other information associated with the game. The user interface 200 can also include a communications interface 230 that enables communications between the game system and the player and between one or more players of the parallel reality game.

According to aspects of the present disclosure, a player can interact with the parallel reality game by carrying a client device around in the real world. For instance, a player can play the game by accessing an application associated with the parallel reality game on a smartphone and moving about in the real world with the smartphone. In this regard, it is not necessary for the player to continuously view a visual representation of the virtual world on a display screen in order to play the location-based game. As a result, the user interface 200 can include non-visual elements that allow a user to interact with the game. For instance, the game interface can provide audible notifications to the player when the player is approaching a virtual element or object in the game or when an important event happens in the parallel reality game. In some embodiments, a player can control these audible notifications with audio control 240. Different types of audible notifications can be provided to the user depending on the type of virtual element or event. The audible notification can increase or decrease in frequency or volume depending on a player's proximity to a virtual element or object. Other non-visual notifications and signals can be provided to the user, such as a vibratory notification or other suitable notifications or signals.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. Players may also be able to obtain enhanced “powers” or virtual items that can be used to complete game objectives within the game.

Those of ordinary skill in the art, using the disclosures provided, will appreciate that numerous game interface configurations and underlying functionalities are possible. The present disclosure is not intended to be limited to any one particular configuration unless it is explicitly stated to the contrary.

### Example Gaming System

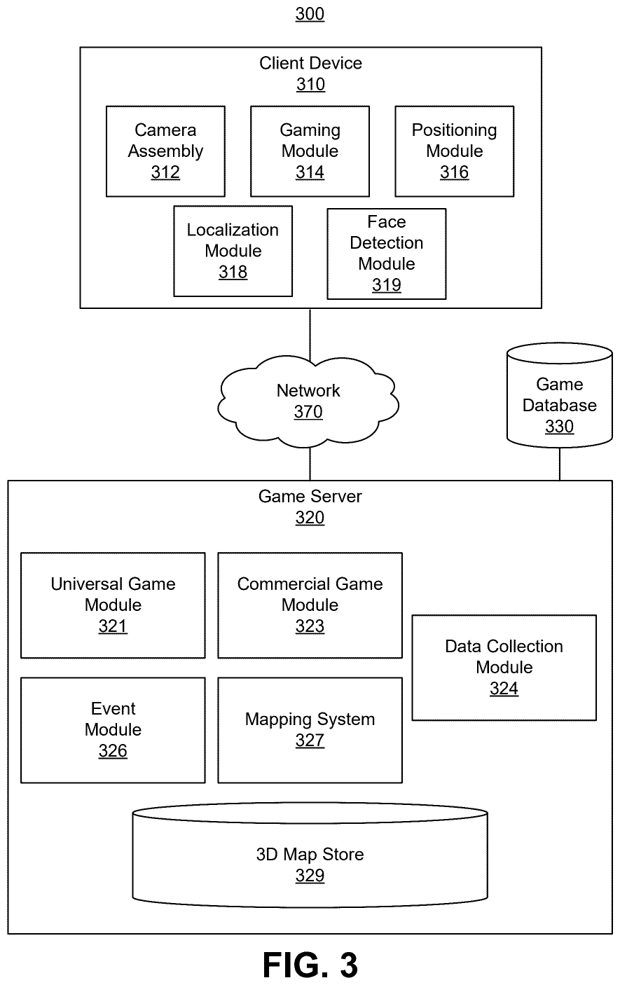

FIG. 3 illustrates one embodiment of a networked computing environment 300. The networked computing environment 300 uses a client-server architecture, where a game server 320 communicates with a client device 310 over a network 370 to provide a parallel reality game to a player at the client device 310. The networked computing environment 300 also may include other external systems such as sponsor/advertiser systems or business systems. Although only one client device 310 is shown in FIG. 3, any number of client devices 310 or other external systems may be connected to the game server 320 over the network 370. Furthermore, the networked computing environment 300 may contain different or additional elements and functionality may be distributed between the client device 310 and the server 320 in different manners than described below.

The networked computing environment 300 provides for the interaction of players in a virtual world having a geography that parallels the real world. In particular, a geographic area in the real world can be linked or mapped directly to a corresponding area in the virtual world. A player can move about in the virtual world by moving to various geographic locations in the real world. For instance, a player's position in the real world can be tracked and used to update the player's position in the virtual world. Typically, the player's position in the real world is determined by finding the location of a client device 310 through which the player is interacting with the virtual world and assuming the player is at the same (or approximately the same) location. For example, in various embodiments, the player may interact with a virtual element if the player's location in the real world is within a threshold distance (e.g., ten meters, twenty meters, etc.) of the real-world location that corresponds to the virtual location of the virtual element in the virtual world. For convenience, various embodiments are described with reference to “the player's location” but one of skill in the art will appreciate that such references may refer to the location of the player's client device 310.

A client device 310 can be any portable computing device capable for use by a player to interface with the game server 320. For instance, a client device 310 is preferably a portable wireless device that can be carried by a player, such as a smartphone, portable gaming device, augmented reality (AR) headset, cellular phone, tablet, personal digital assistant (PDA), navigation system, handheld GPS system, or other such device. For some use cases, the client device 310 may be a less-mobile device such as a desktop or a laptop computer. Furthermore, the client device 310 may be a vehicle with a built-in computing device.

The client device 310 communicates with the game server 320 to provide sensory data of a physical environment. In one embodiment, the client device 310 includes a camera assembly 312, a gaming module 314, a positioning module 316, a localization module 318, and a face detection module 319. The client device 310 also includes a network interface (not shown) for providing communications over the network 370. In various embodiments, the client device 310 may include different or additional components, such as additional sensors, display, and software modules, etc.

The camera assembly 312 includes one or more cameras which can capture image data. The cameras capture image data describing a scene of the environment surrounding the client device 310 with a particular pose (the location and orientation of the camera within the environment). The camera assembly 312 may use a variety of photo sensors with varying color capture ranges and varying capture rates. Similarly, the camera assembly 312 may include cameras with a range of different lenses, such as a wide-angle lens or a telephoto lens. The camera assembly 312 may be configured to capture single images or multiple images as frames of a video.

The client device 310 may also include additional sensors for collecting data regarding the environment surrounding the client device, such as movement sensors, accelerometers, gyroscopes, barometers, thermometers, light sensors, microphones, etc. The image data captured by the camera assembly 312 can be appended with metadata describing other information about the image data, such as additional sensory data (e.g., temperature, brightness of environment, air pressure, location, pose etc.) or capture data (e.g., exposure length, shutter speed, focal length, capture time, etc.).

The gaming module 314 provides a player with an interface to participate in the parallel reality game. The game server 320 transmits game data over the network 370 to the client device 310 for use by the gaming module 314 to provide a local version of the game to a player at locations remote from the game server. In one embodiment, the gaming module 314 presents a user interface on a display of the client device 310 that depicts a virtual world (e.g., renders imagery of the virtual world) and allows a user to interact with the virtual world to perform various game objectives. In some embodiments, the gaming module 314 presents images of the real world (e.g., captured by the camera assembly 312) augmented with virtual elements from the parallel reality game. In these embodiments, the gaming module 314 may generate or adjust virtual content according to other information received from other components of the client device 310. For example, the gaming module 314 may adjust a virtual object to be displayed on the user interface according to a depth map of the scene captured in the image data.

The gaming module 314 can also control various other outputs to allow a player to interact with the game without requiring the player to view a display screen. For instance, the gaming module 314 can control various audio, vibratory, or other notifications that allow the player to play the game without looking at the display screen.

The positioning module 316 can be any device or circuitry for determining the position of the client device 310. For example, the positioning module 316 can determine actual or relative position by using a satellite navigation positioning system (e.g., a GPS system, a Galileo positioning system, the Global Navigation satellite system (GLONASS), the BeiDou Satellite Navigation and Positioning system), an inertial navigation system, a dead reckoning system, IP address analysis, triangulation and/or proximity to cellular towers or Wi-Fi hotspots, or other suitable techniques.

As the player moves around with the client device 310 in the real world, the positioning module 316 tracks the position of the player and provides the player position information to the gaming module 314. The gaming module 314 updates the player position in the virtual world associated with the game based on the actual position of the player in the real world. Thus, a player can interact with the virtual world simply by carrying or transporting the client device 310 in the real world. In particular, the location of the player in the virtual world can correspond to the location of the player in the real world. The gaming module 314 can provide player position information to the game server 320 over the network 370. In response, the game server 320 may enact various techniques to verify the location of the client device 310 to prevent cheaters from spoofing their locations. It should be understood that location information associated with a player is utilized only if permission is granted after the player has been notified that location information of the player is to be accessed and how the location information is to be utilized in the context of the game (e.g., to update player position in the virtual world). In addition, any location information associated with players is stored and maintained in a manner to protect player privacy.

The localization module 318 provides an additional or alternative way to determine the location of the client device 310. In one embodiment, the localization module 318 receives the location determined for the client device 310 by the positioning module 316 and refines it by determining a pose of one or more cameras of the camera assembly 312. The localization module 318 may use the location generated by the positioning module 316 to select a 3D map of the environment surrounding the client device 310 and localize against the 3D map. The localization module 318 may obtain the 3D map from local storage or from the game server 320. The 3D map may be a point cloud, mesh, or any other suitable 3D representation of the environment surrounding the client device 310. Alternatively, the localization module 318 may determine a location or pose of the client device 310 without reference to a coarse location (such as one provided by a GPS system), such as by determining the relative location of the client device 310 to another device.

In one embodiment, the localization module 318 applies a trained model to determine the pose of images captured by the camera assembly 312 relative to the 3D map. Thus, the localization model can determine an accurate (e.g., to within a few centimeters and degrees) determination of the position and orientation of the client device 310. The position of the client device 310 can then be tracked over time using dead reckoning based on sensor readings, periodic re-localization, or a combination of both. Having an accurate pose for the client device 310 may enable the gaming module 314 to present virtual content overlaid on images of the real world (e.g., by displaying virtual elements in conjunction with a real-time feed from the camera assembly 312 on a display) or the real world itself (e.g., by displaying virtual elements on a transparent display of an AR headset) in a manner that gives the impression that the virtual objects are interacting with the real world. For example, a virtual character may hide behind a real tree, a virtual hat may be placed on a real statue, or a virtual creature may run and hide if a real person approaches it too quickly.

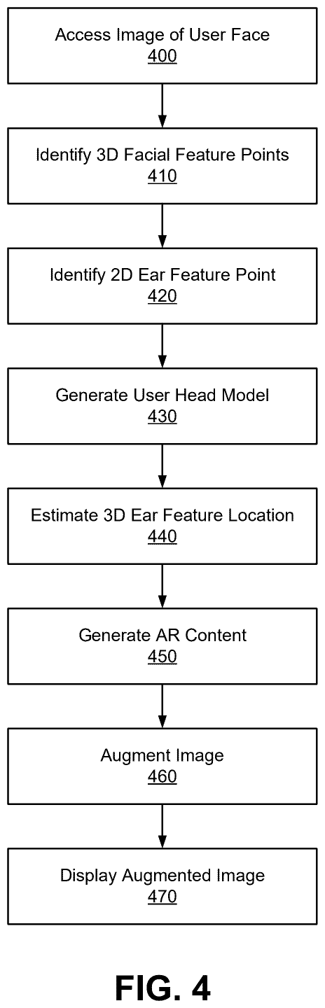

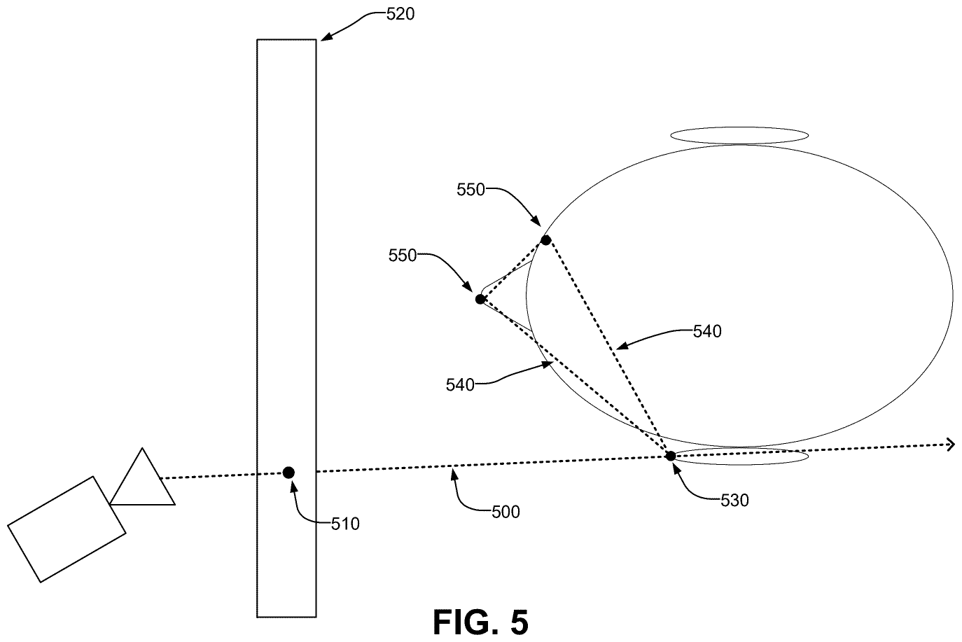

The face detection module 319 detects and analyzes depictions of a user's face in images captured by the camera assembly 312. In one embodiment, the face detection model 319 detects 3D feature points for features of the user's face in images and 2D feature points for ears of the user in the images. The combination of 3D and 2D feature points may be used to model the user's head and provide AR content that interacts with the user's head. For example, a user may be able to wear a virtual helmet or virtual face paint. Various embodiments of providing AR content that interacts with a user's face are described in greater detail below, with reference to FIGS. 4 and 5.

The game server 320 includes one or more computing devices that provide game functionality to the client device 310. The game server 320 can include or be in communication with a game database 330. The game database 330 stores game data used in the parallel reality game to be served or provided to the client device 310 over the network 370.

The game data stored in the game database 330 can include: (1) data associated with the virtual world in the parallel reality game (e.g., image data used to render the virtual world on a display device, geographic coordinates of locations in the virtual world, etc.); (2) data associated with players of the parallel reality game (e.g., player profiles including but not limited to player information, player experience level, player currency, current player positions in the virtual world/real world, player energy level, player preferences, team information, faction information, etc.); (3) data associated with game objectives (e.g., data associated with current game objectives, status of game objectives, past game objectives, future game objectives, desired game objectives, etc.); (4) data associated with virtual elements in the virtual world (e.g., positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g., location of real-world objects/landmarks, description of real-world objects/landmarks, relevance of virtual elements linked to real-world objects, etc.); (6) game status (e.g., current number of players, current status of game objectives, player leaderboard, etc.); (7) data associated with player actions/input (e.g., current player positions, past player positions, player moves, player input, player queries, player communications, etc.); or (8) any other data used, related to, or obtained during implementation of the parallel reality game. The game data stored in the game database 330 can be populated either offline or in real time by system administrators or by data received from users (e.g., players), such as from a client device 310 over the network 370.

In one embodiment, the game server 320 is configured to receive requests for game data from a client device 310 (for instance via remote procedure calls (RPCs)) and to respond to those requests via the network 370. The game server 320 can encode game data in one or more data files and provide the data files to the client device 310. In addition, the game server 320 can be configured to receive game data (e.g., player positions, player actions, player input, etc.) from a client device 310 via the network 370. The client device 310 can be configured to periodically send player input and other updates to the game server 320, which the game server uses to update game data in the game database 330 to reflect any and all changed conditions for the game.

In the embodiment shown in FIG. 3, the game server 320 includes a universal game module 321, a commercial game module 323, a data collection module 324, an event module 326, a mapping system 327, and a 3D map store 329. As mentioned above, the game server 320 interacts with a game database 330 that may be part of the game server or accessed remotely (e.g., the game database 330 may be a distributed database accessed via the network 370). In other embodiments, the game server 320 contains different or additional elements. In addition, the functions may be distributed among the elements in a different manner than described.

The universal game module 321 hosts an instance of the parallel reality game for a set of players (e.g., all players of the parallel reality game) and acts as the authoritative source for the current status of the parallel reality game for the set of players. As the host, the universal game module 321 generates game content for presentation to players (e.g., via their respective client devices 310). The universal game module 321 may access the game database 330 to retrieve or store game data when hosting the parallel reality game. The universal game module 321 may also receive game data from client devices 310 (e.g., depth information, player input, player position, player actions, landmark information, etc.) and incorporates the game data received into the overall parallel reality game for the entire set of players of the parallel reality game. The universal game module 321 can also manage the delivery of game data to the client device 310 over the network 370. In some embodiments, the universal game module 321 also governs security aspects of the interaction of the client device 310 with the parallel reality game, such as securing connections between the client device and the game server 320, establishing connections between various client devices, or verifying the location of the various client devices 310 to prevent players cheating by spoofing their location.

The commercial game module 323 can be separate from or a part of the universal game module 321. The commercial game module 323 can manage the inclusion of various game features within the parallel reality game that are linked with a commercial activity in the real world. For instance, the commercial game module 323 can receive requests from external systems such as sponsors/advertisers, businesses, or other entities over the network 370 to include game features linked with commercial activity in the real world. The commercial game module 323 can then arrange for the inclusion of these game features in the parallel reality game on confirming the linked commercial activity has occurred. For example, if a business pays the provider of the parallel reality game an agreed upon amount, a virtual object identifying the business may appear in the parallel reality game at a virtual location corresponding to a real-world location of the business (e.g., a store or restaurant).

The data collection module 324 can be separate from or a part of the universal game module 321. The data collection module 324 can manage the inclusion of various game features within the parallel reality game that are linked with a data collection activity in the real world. For instance, the data collection module 324 can modify game data stored in the game database 330 to include game features linked with data collection activity in the parallel reality game. The data collection module 324 can also analyze data collected by players pursuant to the data collection activity and provide the data for access by various platforms.

The event module 326 manages player access to events in the parallel reality game. Although the term “event” is used for convenience, it should be appreciated that this term need not refer to a specific event at a specific location or time. Rather, it may refer to any provision of access-controlled game content where one or more access criteria are used to determine whether players may access that content. Such content may be part of a larger parallel reality game that includes game content with less or no access control or may be a stand-alone, access controlled parallel reality game.

The mapping system 327 generates a 3D map of a geographical region based on a set of images. The 3D map may be a point cloud, polygon mesh, or any other suitable representation of the 3D geometry of the geographical region. The 3D map may include semantic labels providing additional contextual information, such as identifying objects tables, chairs, clocks, lampposts, trees, etc.), materials (concrete, water, brick, grass, etc.), or game properties (e.g., traversable by characters, suitable for certain in-game actions, etc.). In one embodiment, the mapping system 327 stores the 3D map along with any semantic/contextual information in the 3D map store 329. The 3D map may be stored in the 3D map store 329 in conjunction with location information (e.g., GPS coordinates of the center of the 3D map, a ringfence defining the extent of the 3D map, or the like). Thus, the game server 320 can provide the 3D map to client devices 310 that provide location data indicating they are within or near the geographic area covered by the 3D map.

The network 370 can be any type of communications network, such as a local area network (e.g., an intranet), wide area network (e.g., the internet), or some combination thereof. The network can also include a direct connection between a client device 310 and the game server 320. In general, communication between the game server 320 and a client device 310 can be carried via a network interface using any type of wired or wireless connection, using a variety of communication protocols (e.g., TCP/IP, HTTP, SMTP, FTP), encodings or formats (e.g., HTML, XML, JSON), or protection schemes (e.g., VPN, secure HTTP, SSL).

This disclosure makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, processes disclosed as being implemented by a server may be implemented using a single server or multiple servers working in combination. Databases and applications may be implemented on a single system or distributed across multiple systems. Distributed components may operate sequentially or in parallel.

In situations in which the systems and methods disclosed access and analyze personal information about users, or make use of personal information, such as location information, the users may be provided with an opportunity to control whether programs or features collect the information and control whether or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

### Example Methods

FIG. 4 is a flowchart describing an example method of tracking the 3D location of a user's ear, according to one embodiment. The steps of FIG. 4 are illustrated from the perspective of the client device performing the method. However, some or all of the steps may be performed by other entities or components. In addition, some embodiments may perform the steps in parallel, perform the steps in different orders, or perform different steps.

The client device accesses 400 an image captured by a camera of the client device. The accessed image depicts the user's face. In some embodiments, the client device captures the image using a front-facing camera that is positioned on the same side as a display of the client device (e.g., a “selfie” camera). Alternatively, the client device may capture the image using a rear-facing camera and the image may depict a different person from the user holding the camera. Additionally, the image may be associated with sensor data captured by a sensor of the client device. For example, the image may be associated with GNSS data, IMU data, gyroscopic data, or magnetometer data.

The client device identifies 410 a set of 3D facial feature points that correspond to depicted facial feature of the user in the image. Facial features are distinct parts of a human's face that contribute to its overall structure and appearance. Example facial features include the eyes, nose, mouth, eyebrows, cheekbones, forehead, and chin of a person's face. The facial feature points are 3D points that represent a location of a corresponding facial feature. Each facial feature may be associated with a single facial feature point (e.g., a center point of the facial feature). Alternatively, some facial features may be associated with multiple facial feature points. For example, a user's eye may be associated with a facial feature point that represents the inner corner of the eye and another point that represents the outer corner of that eye. In some embodiments, the 3D facial feature points are bounding boxes that define an area of the image representing the corresponding facial feature.

The client device may identify the 3D facial feature points by applying a facial feature detection model to the accessed image. The facial feature detection model is a machine-learning model (e.g., a neural network) that is trained to identify the 3D locations of facial features of a user based on an image of the user's face. For example, the facial feature detection model may be trained based on a set of training examples. Each training example may include an image of a user's face and labels describing the 3D locations of facial features that are depicted in the image. In some embodiments, the facial feature detection model uses sensor data captured by sensors of the client device to identify the 3D facial feature points. Furthermore, the facial feature detection model may be a single model that identifies the 3D facial feature points or may be a set of models that together identify the 3D facial feature points.

The client device identifies 420 a set of 2D ear feature points depicted in the image. An ear feature is a distinct part of the user's ear that contributes to the structure or appearance of the ear. Example ear features include the ear lobe or ear canal. The 2D ear feature point is a point in the image that corresponds to an ear feature. For example, the 2D ear feature point may be the coordinates for the pixel or pixels of the image corresponding to the feature point. Like with the 3D facial feature points, each ear feature may correspond to one 2D ear feature point or may have multiple ear feature points that represent different portions of the ear feature. Similarly, the ear feature points may be points or may be bounding boxes that correspond to the ear feature.

The client device may use an ear feature detection model to identify the 2D ear feature point. An ear feature detection model is a machine-learning model that is trained to identify 2D ear feature detection points depicted in an image. For example, the ear feature detection model may be trained based on a set of training examples. Each training example may include an image of a user's face and labels describing the 2D locations of ear features that are depicted in the image.

The client device generates 430 a user head model for the user based on the identified 3D facial feature points and 2D ear feature points. A user head model is a model that describes the relative 3D locations of facial features and ear features on the user's head. For example, the user head model may describe the relative 3D position of each ear feature relative to one or more 3D facial features.

The client device may use a feature relationship model to generate the user head model. A feature relationship model is a model that describes general relationships between facial features and ear features of users. The feature relationship model may include statistical distributions that represent historical distances and directions between facial features and ear features. For example, the feature relationship model may include historical distributions for x-, y-, and z-values of a vector from a user's nose 3D facial feature point to a 3D point for the user's ear lobe. The client device may generate the user head model by applying an objective function to the general relationships described by the feature relationship model, the identified 3D facial feature points, and the 2D ear feature points. For example, the client device may iteratively predict a set of relative 3D positions of the ear feature points and the facial features and may use the objective function to score the predictions. The client device may iteratively adjust these predictions (e.g., using gradient descent) to select a set of 3D positions of the ear feature points and the facial feature points to generate the user head model.

In some embodiments, the client device uses the feature relationship model by constraining the possible 3D locations of an ear feature to a ray line based on the 2D ear feature point. Specifically, the client device may create a 3D ray line that extends from the camera through the 2D ear feature point. The client device may use relationships between the facial features corresponding to the identified 3D facial feature points and the ear feature to predict a 3D point for the ear feature based on the set of 3D points that lie on the 3D ray line and meet the relationships described by the feature relationship model.

FIG. 5 illustrates an example use of a ray line 500 projected through a 2D ear feature point 510 identified on an image 520, according to one embodiment. As described above, the client device identifies a 2D ear feature point 510 on the image that indicates where the ear feature 530 of the user is depicted in the image. The client device projects a ray line 500 through the 2D ear feature point 510 to represent the possible 3D points on which the ear feature 530 may lie. The client device uses the relationships 540 between facial features 550 and the ear feature 530 stored by a feature relationship model to predict a 3D point 530 on or near the ray line at which the ear feature is located.

In some embodiments, the client device generates the user head model based on a set of accessed images. For example, the client device may capture multiple images using its camera and identify 3D facial feature points and 2D ear feature points in each of the images. The client device may generate a user head model with relationships between the 3D facial feature points and the 3D ear feature points that approximate the 3D facial feature points and the 3D ear feature points identified by the client device.

The client device uses the user head model to estimate 440 a 3D ear feature location relative to the physical world. The user head model may simply describe the 3D location of the ear feature relative to 3D facial feature locations. To estimate the 3D ear feature location, the client device may use the 3D facial feature locations, which may be identified relative to the physical world, to compute a transformation from the user head model to the physical world. The client device may use this transformation to estimate the 3D ear feature location relative to the physical world.

The client device generates 450 AR content based on the estimated ear feature location. For example, the client device may generate AR content that appears to modify the user's ear, such as with a virtual earring or with a different color or shape of ear. The client device augments the image (or set of images) to include the generated AR content and displays 470 the augmented image to the user through the display of the client device. In embodiments where some or all of the steps of the method are performed by an online system (e.g., a game server 320), displaying the image may include transmitting the augmented image to the client device for display.

The client device may estimate the 3D ear feature location and generate the AR content based on an image used to generate the user head model. Alternatively, the client device may estimate the 3D ear feature location and generate the AR content based on a different image captured after the image(s) used to generate the user head model.

The client device may continually use the user head model for additional images captured by the client device to estimate the 3D position of ear features. For example, when the user head model is generated, the client device may simply identify the 3D facial feature points (e.g., using a facial feature detection model) and estimate the 3D positions of ear features based on the user head model. Thus, the client device can generate estimates of 3D positions of ear features in images without having to apply an ear feature detection model to each image.

In some embodiments, the client device updates the user head model or generates a new model. For example, the client device may compute how much the user's head has rotated from when the user head model was first generated. If the rotation exceeds some threshold (e.g., 5-10 degrees), the client device may trigger a process to generate a new user head model or to update the parameters of the existing user head model.

### Example Computing System

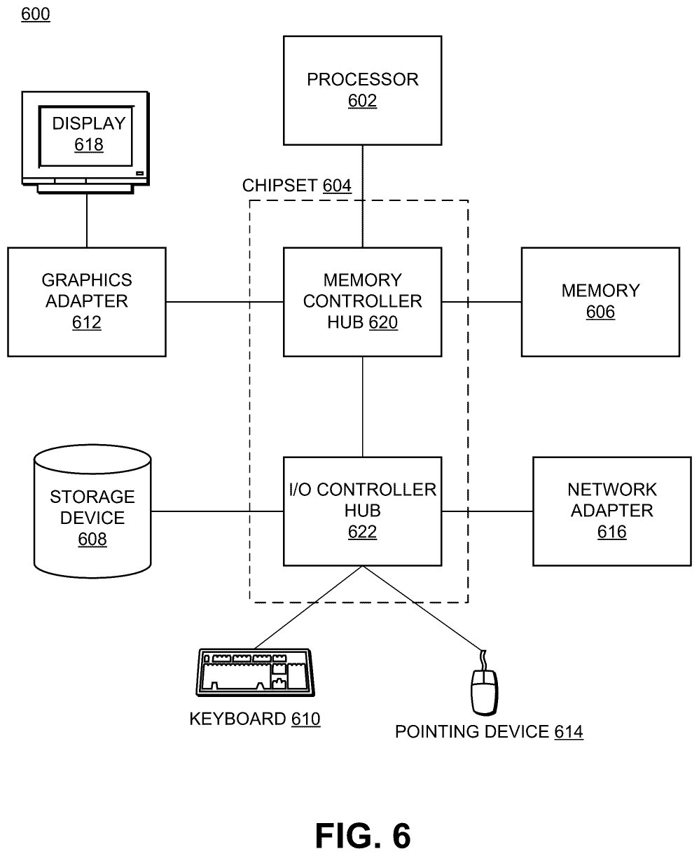

FIG. 6 is a block diagram of an example computer 600 suitable for use as a client device 310 or game server 320. The example computer 600 includes at least one processor 602 coupled to a chipset 604. References to a processor (or any other component of the computer 600) should be understood to refer to any one such component or combination of such components working cooperatively to provide the described functionality. The chipset 604 includes a memory controller hub 620 and an input/output (I/O) controller hub 622. A memory 606 and a graphics adapter 612 are coupled to the memory controller hub 620, and a display 618 is coupled to the graphics adapter 612. A storage device 608, keyboard 610, pointing device 614, and network adapter 616 are coupled to the I/O controller hub 622. Other embodiments of the computer 600 have different architectures.

In the embodiment shown in FIG. 6, the storage device 608 is a non-transitory computer-readable storage medium such as a hard drive, compact disk read-only memory (CD-ROM), DVD, or a solid-state memory device. The memory 606 holds instructions and data used by the processor 602. The pointing device 614 is a mouse, track ball, touch-screen, or other type of pointing device, and may be used in combination with the keyboard 610 (which may be an on-screen keyboard) to input data into the computer system 600. The graphics adapter 612 displays images and other information on the display 618. The network adapter 616 couples the computer system 600 to one or more computer networks, such as network 370.

The types of computers used by the entities of FIG. 3 can vary depending upon the embodiment and the processing power required by the entity. For example, the game server 320 might include multiple blade servers working together to provide the functionality described. Furthermore, the computers can lack some of the components described above, such as keyboards 610, graphics adapters 612, and displays 618.

### ADDITIONAL CONSIDERATIONS

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing the described functionality. Thus, while particular embodiments and applications have been illustrated and described, it is to be understood that the described subject matter is not limited to the precise construction and components disclosed. The scope of protection should be limited only by the following claims.

What is claimed is:

1. A computer-implemented method comprising:
accessing a first image captured by a camera of a client device, wherein the first image depicts a face of a user;
identifying a first plurality of 3D facial feature points by applying a facial feature detection model to the first image, wherein each of the facial feature points identifies a 3D location of a facial feature of the user;
identifying a 2D ear feature point by applying an ear feature detection model to the first image, wherein the ear feature detection model is a machine-learning model trained to identify a location of an ear feature in an image, wherein the ear feature corresponds to a location on an ear of the user;
generating a user head model based on the 2D ear feature point, the first plurality of 3D facial feature points, and a feature relationship model that describes relationships between facial features and ear features of users;
accessing a second image captured by a camera of the client device, wherein the second image depicts the face of the user;
identifying a second plurality of 3D facial feature points based on the second image;
estimating a 3D ear feature location for the ear feature based on the user head model and the second plurality of 3D facial feature points;
generating augmented reality content based on the estimated 3D feature location;
augmenting the second image to include the augmented reality content; and
displaying the augmented image to the user through the client device.

2. The method of claim 1, wherein the 2D ear feature point comprises coordinates for a pixel in the image depicting the ear feature.

3. The method of claim 2, wherein the 2D ear feature point describes a set of coordinates for a set of pixels in the image depicting the ear feature.

4. The method of claim 1, wherein identifying a first plurality of 3D facial feature points comprises:
identifying a first plurality of 3D facial feature points for a facial feature of the user.

5. The method of claim 1, wherein generating the user head model comprises:
applying an objective function to the 2D ear feature point, the first plurality of 3D facial feature points, and the feature relationship model.

6. The method of claim 1, wherein generating the user head model comprises:
generating the user head model based on 2D ear feature points and 3D facial feature points identified based on a plurality of images captured by the camera of the client device.

7. The method of claim 1, wherein the feature relationship model comprises statistical distributions of values representing a vector between a facial feature and the ear feature.

8. The method of claim 1, wherein estimating a 3D ear feature location comprises:
calculating a transformation from locations on the user head model to the physical world based on the 3D facial feature points.

9. The method of claim 1, wherein displaying the augmented image comprises:
transmitting the augmented image to the client device from a game server.

10. The method of claim 1, further comprising:
accessing a third image captured by the camera of the client device;
identifying a third plurality of 3D facial feature points based on the third image;
calculating a rotation of the user's head based on the third plurality of 3D facial feature points; and
responsive to the rotation exceeding a threshold value, generating a new user head model based on the third plurality of 3D facial feature points, a new 2D ear feature point identified in the third image, and the feature relationship model.

11. A non-transitory computer-readable medium storing instructions that, when executed by a processor, cause the processor to perform operations comprising:
accessing a first image captured by a camera of a client device, wherein the first image depicts a face of a user;
identifying a first plurality of 3D facial feature points by applying a facial feature detection model to the first image, wherein each of the facial feature points identifies a 3D location of a facial feature of the user;
identifying a 2D ear feature point by applying an ear feature detection model to the first image, wherein the ear feature detection model is a machine-learning model trained to identify a location of an ear feature in an image, wherein the ear feature corresponds to a location on an ear of the user;
generating a user head model based on the 2D ear feature point, the first plurality of 3D facial feature points, and a feature relationship model that describes relationships between facial features and ear features of users;
accessing a second image captured by a camera of the client device, wherein the second image depicts the face of the user;
identifying a second plurality of 3D facial feature points based on the second image;
estimating a 3D ear feature location for the ear feature based on the user head model and the second plurality of 3D facial feature points;
generating augmented reality content based on the estimated 3D feature location;
augmenting the second image to include the augmented reality content; and
displaying the augmented image to the user through the client device.

12. The computer-readable medium of claim 11, wherein the 2D ear feature point comprises coordinates for a pixel in the image depicting the ear feature.

13. The computer-readable medium of claim 12, wherein the 2D ear feature point describes a set of coordinates for a set of pixels in the image depicting the ear feature.

14. The computer-readable medium of claim 11, wherein identifying a first plurality of 3D facial feature points comprises:
identifying a first plurality of 3D facial feature points for a facial feature of the user.

15. The computer-readable medium of claim 11, wherein generating the user head model comprises:
applying an objective function to the 2D ear feature point, the first plurality of 3D facial feature points, and the feature relationship model.

16. The computer-readable medium of claim 11, wherein generating the user head model comprises:
generating the user head model based on 2D ear feature points and 3D facial feature points identified based on a plurality of images captured by the camera of the client device.

17. The computer-readable medium of claim 11, wherein the feature relationship model comprises statistical distributions of values representing a vector between a facial feature and the ear feature.

18. The computer-readable medium of claim 11, wherein estimating a 3D ear feature location comprises:
calculating a transformation from locations on the user head model to the physical world based on the 3D facial feature points.

19. The computer-readable medium of claim 11, wherein displaying the augmented image comprises:
transmitting the augmented image to the client device from a game server.

20. The computer-readable medium of claim 11, the operations further comprising:
accessing a third image captured by the camera of the client device;
identifying a third plurality of 3D facial feature points based on the third image;
calculating a rotation of the user's head based on the third plurality of 3D facial feature points; and
responsive to the rotation exceeding a threshold value, generating a new user head model based on the third plurality of 3D facial feature points, a new 2D ear feature point identified in the third image, and the feature relationship model.
